(19) United States
(12) Patent Application Publication
(10) Pub. No.: US 2024/0012168 A1
(43) Pub. Date: Jan. 11, 2024

(54) MITIGATION OF COUPLING NOISE IN DISTRIBUTED ACOUSTIC SENSING (DAS) VERTICAL SEISMIC PROFILING (VSP) DATA USING MACHINE LEARNING

(71) Applicant: Halliburton Energy Services, Inc., Houston, TX (US)

(72) Inventors: Satyan SINGH, Didcot (UA); Mark WILLIS, Katy, TX (US)

(73) Assignee: Halliburton Energy Services, Inc., Houston, TX (US)

(21) Appl. No.: 18/200,727

(22) Filed: May 23, 2023

Related U.S. Application Data
(60) Provisional application No. 63/359,265, filed on Jul. 8, 2022.

(51) Int. Cl. G01V 1/28

(52) U.S. Cl. CPC G01V 1/282

(57) ABSTRACT

Systems and techniques are provided for processing wellbore data to generate denoised seismic data where a coupling noise is eliminated. An example method can include receiving wellbore data comprising one or more seismic measurements; generating a seismic input image based on seismic measurements; processing the seismic input image to remove a zigzag noise in the seismic input image. The zigzag noise represents noise in the corresponding seismic measurements. The example method can further include outputting a denoised seismic image. Systems and machine-readable media are also provided.

### CROSS-REFERENCE TO RELATED APPLICATIONS

This application claims benefit to U.S. Provisional Application No. 63/359,265 filed Jul. 8, 2022, which is incorporated herein by reference.

### TECHNICAL FIELD

The subject matter of this disclosure relates to the analysis of vertical seismic profiling data sets and in particular, to the use of a machine learning model to generate denoised seismic data where coupling noise within fiber optic distributed acoustic sensing datasets has been eliminated.

### BACKGROUND

Fiber-optic sensors are increasingly used in wellbore operations, for example, to facilitate sensing some quantity, typically temperature or mechanical strain, but sometimes also displacements, vibrations, pressure, acceleration, rotations, or concentrations of chemical species. The general principle of such devices is that light from a laser is sent through an optical fiber and after experiencing some changes of its parameters, either in the fiber or in one or several fiber Bragg gratings, then reaches a detector arrangement which measures these changes.

In particular, a growing application field is the use of fiber optic sensing system for acoustic sensing, especially Distributed Acoustic Sensing (DAS). DAS is quickly becoming recognized as a powerful tool for remote downhole sensing. The list of existing and potential applications for this new technology is long and continues to grow.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1A is a schematic side-view of a wireline logging environment.

FIG. 1B is a schematic side-view of the logging environment of FIG. 1A.

FIG. 2 illustrates an example of a seismic image for a vertical seismic profile dataset, according to some aspects of the disclosed technology.

FIG. 3 illustrates an example of a noise image that identifies noise in the seismic image of FIG. 2, according to some aspects of the disclosed technology.

FIG. 4 illustrates an example of a denoised seismic image where a noise region is eliminated in the seismic image of FIG. 2, according to some aspects of the disclosed technology.

FIG. 5 is a diagram illustrating an example generative adversarial network model, according to some aspects of the disclosed technology.

FIG. 6 is a diagram illustrating an example discriminator network model, according to some aspects of the disclosed technology.

FIG. 7 is a diagram illustrating an example configuration of a neural network model, according to some aspects of the disclosed technology.

FIG. 8 illustrates an example of synthetic seismic data records that can be used to facilitate the training of a machine learning model, according to some aspects of the disclosed technology.

FIG. 9 illustrates an example of a synthetic noise image that identifies a noise region in the synthetic seismic data of FIG. 8, according to some aspects of the disclosed technology.

FIG. 10 illustrates an example of a synthetic denoised seismic image where a noise region is eliminated in the synthetic seismic image of FIG. 8, according to some aspects of the disclosed technology.

FIG. 11 illustrates an example of a synthetic zigzag noise that can be added to a seismic record, according to some aspects of the disclosed technology.

FIG. 12 is a flowchart illustrating an example process for removing a noise region in a seismic image, according to some aspects of the disclosed technology.

FIG. 13 illustrates a computing device that can be used to implement some aspects of the disclosed technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Vertical seismic profile (VSP) is a measurement technique used for seismic monitoring of a geologic formation. There are different types of VSP with most sharing the characteristic that a seismic sensor system is disposed in a wellbore. A distributed acoustic sensing (DAS) system is one type of seismic sensor system utilized for VSP. The DAS system utilizes downhole distributed acoustic sensors, such as optical fibers, as sensing elements to detect seismic waves incident on the distributed acoustic sensor resulting from an acoustic source outputting acoustic energy at or near the surface of the wellbore. The DAS system typically utilizes Rayleigh backscattered of laser light energy to spatially detect deformation (often referred to as strains) distributed along the optical fibers. The backscattered light is processed to determine light phase differences caused by the strains and changes in the strain along the optical fiber which in turn is translated to measurements of seismic waves incident on the distributed acoustic sensor at different depths in the wellbore. Depending on the implementation, the seismic data (or wellbore data) can be used to determine rock properties in the geologic formation, such as where hydrocarbons are present in the formation.

A wireline or coiled tubing based fiber-optic cable can be deployed for acquiring DAS VSP data. In a vertical well using a wireline cable with an embedded optical fiber, the fiber might hang without touching the casing or formation. As a result, the fiber optic cable might not be acoustically coupled to a borehole wall. Under these conditions, a reverberating noise train, often referred to as “zigzag noise” can appear in the distributed acoustic sensing vertical seismic profile records (e.g., seismic measurements) in zones with poor coupling, for example, decoupling between the fiber optic cable and the casing. The zigzag noise propagates trapped in the uncoupled zone, first down the cable and then back upwards. As follows, in the zones with poor coupling, a high amplitude zigzag noise obscures the down-going signals, which are used for velocity analysis, and contaminates the up-going reflection data that are used for imaging.

Systems, apparatuses, processes (also referred to as methods), and computer-readable media (collectively referred to as “systems and techniques” or “system”) are described herein for mitigating noise in acquired seismic data (e.g., VSP data). For example, the systems and techniques described herein can improve wellbore data collection by providing solutions for mitigating coupling noise in DAS VSP data using machine learning. In some examples, the systems and techniques can identify and mitigate coupling noise (e.g., zigzag noise) in DAS VSP records through a machine learning algorithm such as a generative adversarial network. For example, a machine-learning model can output denoised seismic data, in which a DAS coupling noise (e.g., zigzag noise) is eliminated. As follows, the systems and techniques can improve the quality of the VSP records and provide more reliable seismic data for analyzing subsurface formation properties.

In some examples, the systems and techniques described herein can utilize synthetic data that includes simulated noise (e.g., synthetic zigzag noise) as a training dataset for training a machine learning algorithm. For example, the training dataset can be used with a generative adversarial network (GAN) to create a noise mitigation algorithm to eliminate the noise in DAS VSP records (e.g., zigzag noise).

In some approaches, a training dataset for training a machine learning algorithm (e.g., neural network) can be constructed with real data (e.g., real seismic data captured by one or more devices, such as sensors (e.g., optical fiber cables) in the field during VSP data acquisition). For example, a coupling noise (e.g., zigzag noise) can be randomly added to real data that does not have any coupling noise on the fly within the network. This can improve the robustness of the learning, especially if clean data is part of the prediction dataset. In another example, the training dataset can be augmented to look like the application (e.g., prediction) dataset. The augmentation of the training dataset can include domain adoption (e.g., using machine-learning techniques) or the techniques as described in the present disclosure.

In some aspects, the disclosed denoising process techniques can be utilized to eliminate noise in DAS VSP data by employing machine-learning (ML) techniques, such as the use of generative adversarial networks and/or deep-learning approaches. However, it is understood that the ML architectures and applications described herein are provided for explanatory purposes, and are not intended to be limiting in scope. As such, those of skill in the art will recognize that other image processing and/or ML techniques can be implemented, without departing from the scope of the disclosed technology.

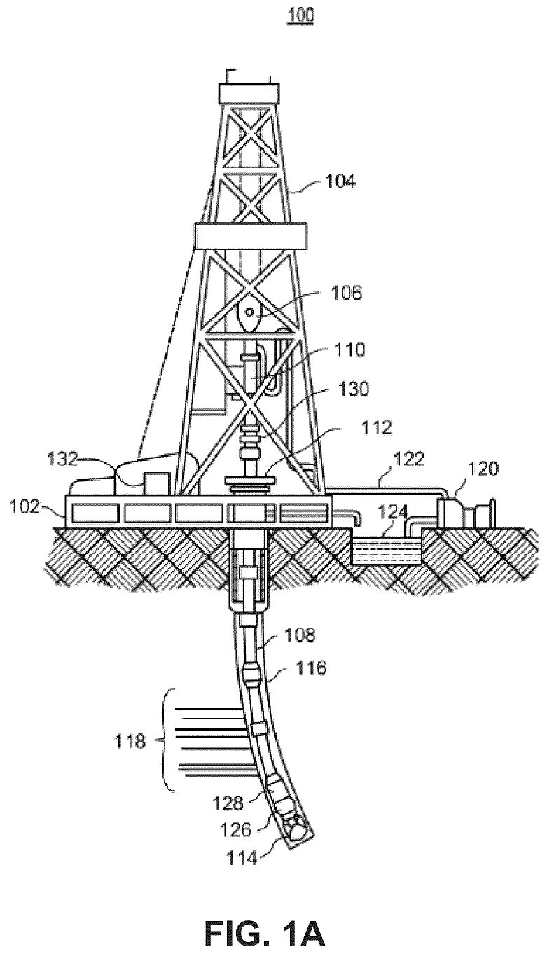

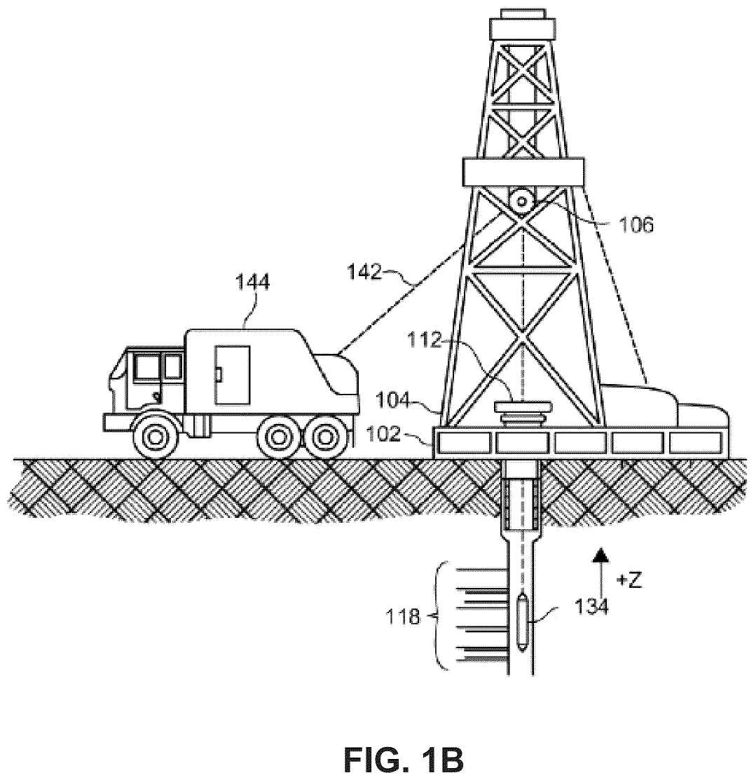

The disclosure now turns to FIG. 1A, which illustrates an example logging while drilling (LWD) environment. A drilling platform 102 supports derrick 104 having traveling block 106 for raising and lowering drill string 108. Kelly 110 supports drill string 108 as it is lowered through rotary table 112. Drill bit 114 is driven by a downhole motor and/or rotation of drill string 108. As drill bit 114 rotates, it drills a borehole 116 that passes through various formations 118. Pump 120 circulates drilling fluid through a feed pipe 122 to kelly 110, downhole through the interior of drill string 108, through orifices in drill bit 114, back to the surface via the annulus around drill string 108, and into retention pit 124. The drilling fluid transports cuttings from the borehole into pit 124 and aids in maintaining borehole integrity.

Downhole tool 126 can take the form of a drill collar (i.e., a thick-walled tubular that provides weight and rigidity to aid the drilling process) or other arrangements known in the art. Further, downhole tool 126 can include acoustic (e.g., sonic, ultrasonic, etc.) logging tools and/or corresponding components, integrated into the bottom-hole assembly near drill bit 114. In this fashion, as drill bit 114 extends the borehole through formations, the bottom-hole assembly (e.g., the acoustic logging tool) can collect acoustic logging data. For example, acoustic logging tools can include transmitters (e.g., monopole, dipole, quadrupole, etc.) to generate and transmit acoustic signals/waves into the borehole environment. These acoustic signals subsequently propagate in and along the borehole and surrounding formation and create acoustic signal responses or waveforms, which are received/recorded by evenly spaced receivers. These receivers may be arranged in an array and may be evenly spaced apart to facilitate capturing and processing acoustic response signals at specific intervals. The acoustic response signals are further analyzed to determine borehole and adjacent formation properties and/or characteristics. Depending on the implementation, other logging tools may be deployed. For example, logging tools configured to measure electric, nuclear, gamma and/or magnetism levels may be used. Logging tools can also be implemented to measure pressure, temperature, perform fluid identification and/or measure tool orientation, etc.

For purposes of communication, a downhole telemetry sub 128 can be included in the bottom-hole assembly to transfer measurement data to surface receiver 130 and to receive commands from the surface. Mud pulse telemetry is one common telemetry technique for transferring tool measurements to surface receivers and receiving commands from the surface, but other telemetry techniques can also be used, including fiber optic telemetry, electric telemetry, acoustic telemetry through the pipe, electromagnetic (EM) telemetry, etc. In some embodiments, telemetry sub 128 can store logging data for later retrieval at the surface when the logging assembly is recovered.

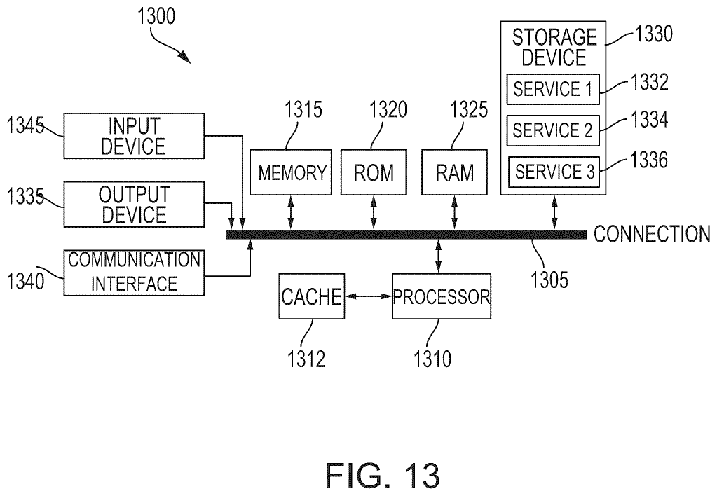

At the surface, surface receiver 130 can receive the uplink signal from the downhole telemetry sub 128 and can communicate the signal to data acquisition module 132. Module 132 can include one or more processors, storage mediums, input devices, output devices, software, and the like as described in detail with respect to FIG. 13, below. Module 132 can collect, store, and/or process the data received from tool 126 as described herein.

At various times during the process of drilling a well, drill string 108 may be removed from the borehole as shown in FIG. 1B. Once drill string 108 has been removed, logging operations can be conducted using a downhole tool 134 (i.e., a sensing instrument sonde) suspended by a conveyance 142. In one or more embodiments, conveyance 42 can be a cable having conductors for transporting power to the tool and telemetry from the tool to the surface. Downhole tool 134 may have pads and/or centralizing springs to maintain the tool near the central axis of the borehole or to bias the tool towards the borehole wall as the tool is moved downhole or uphole.

Downhole tool 134 can include an acoustic or sonic logging instrument that collects acoustic logging data within the borehole 116. As mentioned above, other logging instruments may also be used. A logging facility 144 includes a computer system, such as those described with reference to FIG. 13, for collecting, storing, and/or processing the data/measurements gathered by logging tool 134. In one or more embodiments, the conveyance 142 of the downhole tool 134 may be at least one of wires, conductive or non-conductive cable (e.g., slickline, etc.), as well as tubular conveyances, such as coiled tubing, pipe string, or downhole tractor. Downhole tool 134 can have a local power supply, such as batteries and/or a downhole generator, or the like. When employing non-conductive cable, coiled tubing, pipe string, or downhole tractor, communication can be supported using, for example, wireless protocols (e.g. EM, acoustic, etc.), and/or measurements and logging data may be stored in local memory for subsequent retrieval. In some aspects, electric or optical telemetry is provided using conductive cables and/or fiber optic signal-paths.

Although FIGS. 1A and 1B depict specific borehole configurations, it is understood that the present disclosure is suited for use in wellbores having other orientations including vertical wellbores, horizontal wellbores, slanted wellbores, multilateral wellbores and the like. While FIGS. 1A and 1B depict an onshore operation, it should also be understood that the present disclosure is equally well suited for use in offshore operations. Moreover, the present disclosure is not limited to the environments depicted in FIGS. 1A and 1B, and can also be used, for example, in other well operations such as production tubing operations, jointed tubing operations, coiled tubing operations, combinations thereof, and the like.

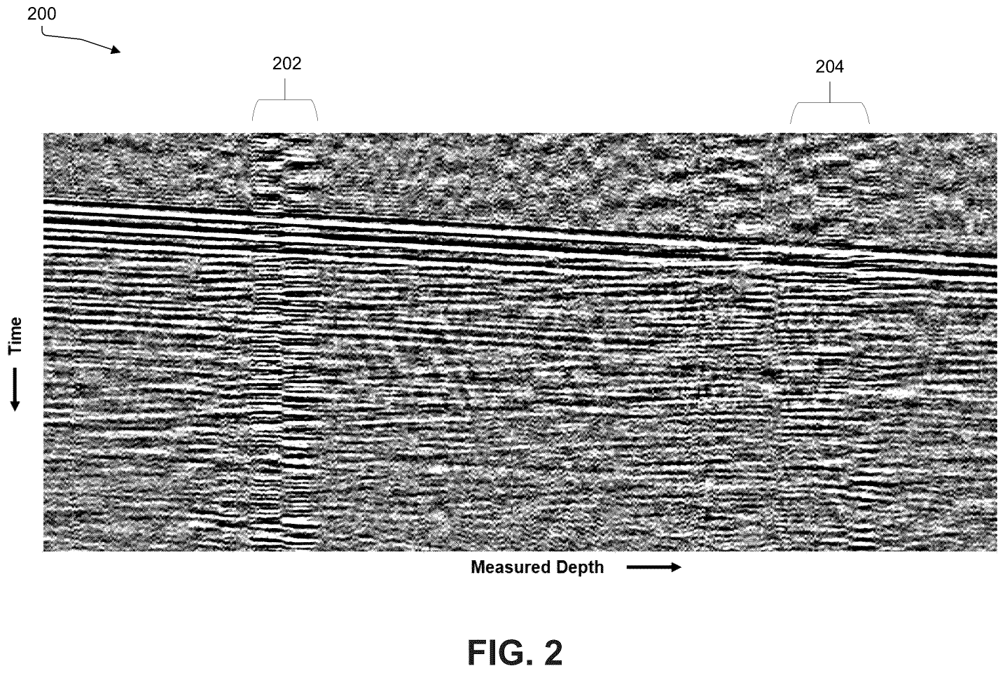

FIG. 2 illustrates an example of a seismic image 200 of a vertical seismic profile (VSP) dataset. In some examples, seismic image 200 can be acquired using a distributed acoustic sensing (DAS) system, which uses one or more optical fiber cables in a wellbore (e.g., in a wireline logging environment depicted in FIGS. 1A and 1B). As shown in FIG. 2, the seismic image 200 can represent a spatial relationship between wellbore depth (e.g., on the x-axis) and time (e.g., on the y-axis) with respect to seismic measurements. In some examples, the wellbore depth can be indicated by a channel number. For example, a seismic measurement can be measured by the optical fiber cable(s) at every meter or channel (e.g., 1,000 channels of data for 1,000 meters long) at every tick or second.

As shown, the seismic image 200 can include one or more noise regions 202, 204 comprising zigzag noise. In some examples, each of noise regions 202, 204 can have various dimensions and can be seen occurring at different wellbore depths or channels. The noise regions 202, 204 corresponding to noise data obscure the seismic measurements/signals and may be desired to be eliminated from the dataset. In some examples, the noise regions 202, 204 comprising the zigzag noise can be removed using a machine-learning model, for example, a deep-learning-based model such as a generative adversarial network (GAN), as discussed in further detail below.

In some aspects, the seismic image 200 can be provided as input image data (e.g., a seismic input image) to a machine-learning network that is configured to identify and eliminate zigzag noise (e.g., in the noise regions 202, 204) within the seismic image 200. The output of the machine-learning network can include denoised seismic data where the zigzag noise has been removed. Instead of identifying a noise region within VSP records using a machine learning model and subsequently removing the noise region within the VSP records using noise attenuation/elimination techniques, the disclosed technology can process VSP records comprising a noise region to generate a denoised/mitigated VSP records using a machine learning framework. It is understood that various machine-learning approaches, including but not limited to the use of other network architectures, can be used depending on the desired implementation, without departing from the scope of the disclosed technology.

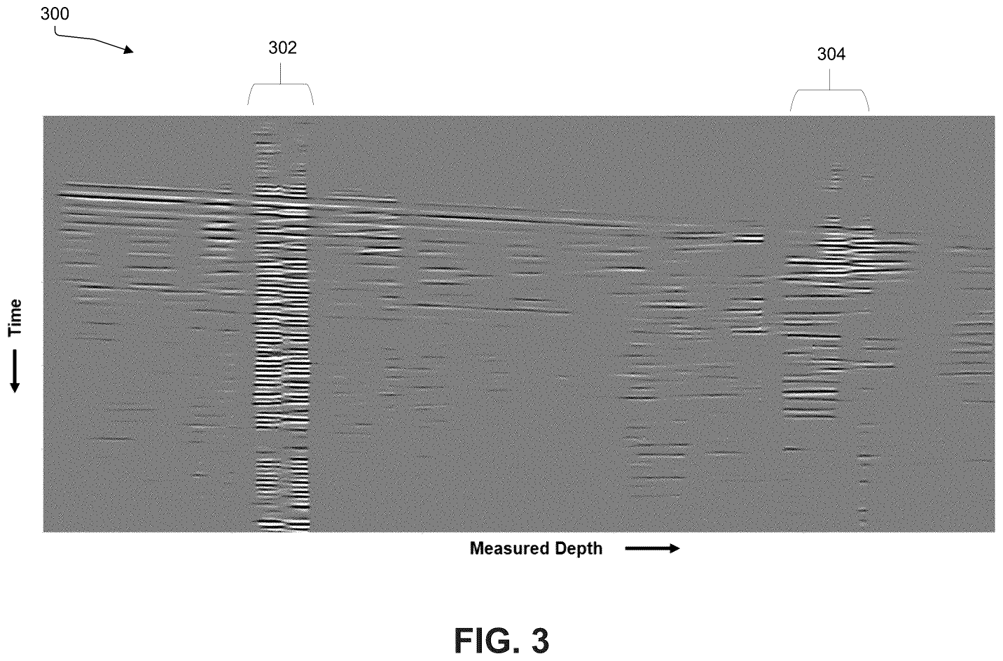

FIG. 3 illustrates an example of a noise image 300 comprising noise regions 302, 304. In some examples, the noise image 300 comprises zigzag noise in the noise regions 302, 304, which correspond to the noise regions 202, 204, respectively, in the seismic image 200 of FIG. 2. In some examples, the zigzag noise (e.g., DAS coupling noise) in the noise regions 302, 304 can be identified and extracted from the seismic image 200 of FIG. 2 using a machine learning technique such as a deep-learning-based model.

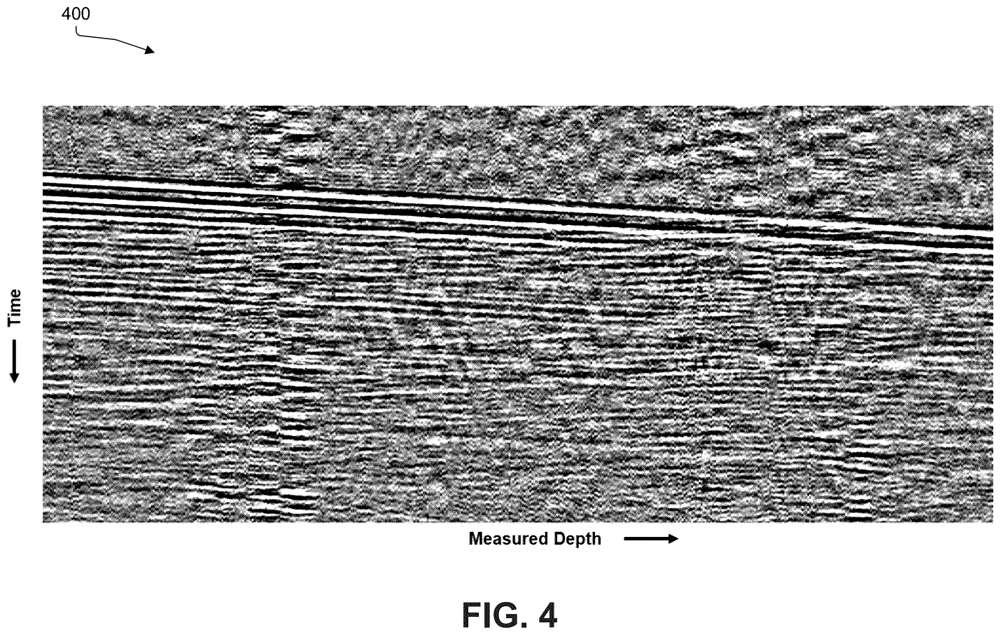

FIG. 4 illustrates an example of a denoised seismic image 400 where a noise (e.g., zigzag noise in the noise regions 202, 204) is eliminated from the seismic image 200 of FIG. 2. For example, the denoised seismic image 400 illustrates the mitigated VSP record created by subtracting the estimated zigzag noise (e.g., the zigzag noise in the noise regions 202, 204 or 302, 304) from the input VSP record (e.g., seismic image 200). In some examples, seismic data (e.g., seismic image 200) can be provided to a machine-learning model, which eliminates a noise region identified in the seismic data and outputs a denoised seismic image (e.g., denoised seismic image 400). For example, a noise region containing a zigzag noise can be not only identified but also removed using a machine learning framework, which is configured to directly output mitigated seismic data (e.g., denoised seismic image 400).

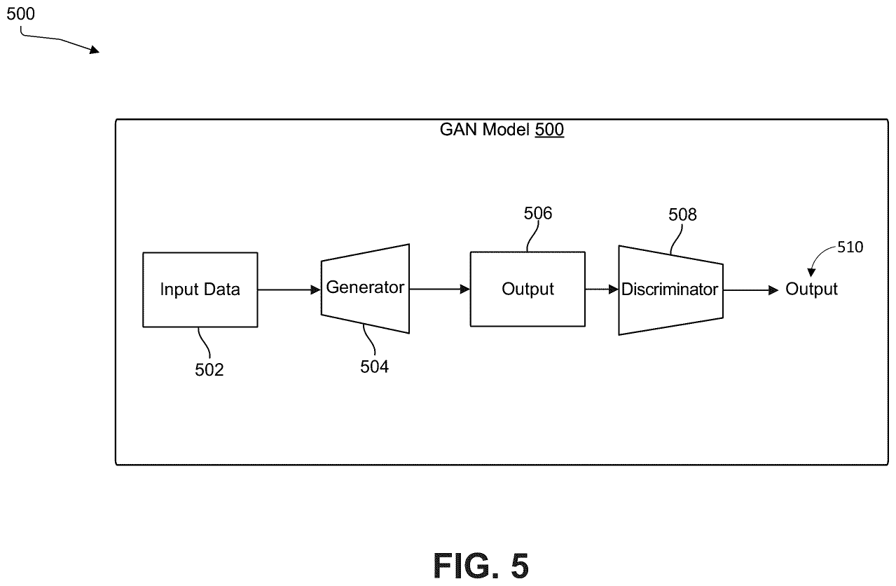

FIG. 5 illustrates an example of a GAN model 500 used to generate denoised seismic data (e.g., denoised seismic image 400 as illustrated in FIG. 4) according to some examples of the disclosure. In this example, the GAN model 500 includes a generator 504 (e.g., generative neural network, generative model, etc.) and a discriminator 508 (e.g., discriminative neural network, discriminative model, etc.). The GAN model 500 involves the simultaneous training of the generator 504 and the discriminator 508 based on a loss function that reflects the distance between the distribution of the data generated by the GAN and the real data. For example, the discriminator 508 of 32 tries to maximize the loss function (e.g., maximizing the probability assigned to real and fake data) while the generator 504 tries to minimize the loss function.

In some examples, the GAN model 500 that is configured to generate denoised seismic data can use a loss function that includes an absolute error loss (LI) norm of reconstruction only around the noise (e.g., zigzag noise) within the seismic data, while other locations have a null contribution to this loss.

The generator 504 can receive input data 502 used to generate a type of data such as, for example, image data. The input data 502 can include, for example, training data used to train the generator 504 to generate a desired type of data, random data associated with a desired type of output (e.g., of the same type as the desired output such as image data), noise sampled from the output space or domain, etc. In some examples, the generator 504 can learn to decouple the noise from the signal and identify noise (e.g., zigzag noise) within the input data 502 by removing the non-noise signals and keeping the noise.

In some cases, the generator 504 can generate an output 506 based on the input data 502. The output 506 can include and/or represent fake data that has a threshold similarity to and/or is undistinguishable from (e.g., to a human and/or a network, such as a discriminator network) real data captured by a DAS system using one or more optical fiber cables in VSP data acquisition. For example, the output 506 can include a fake (e.g., synthetic) image that appears like and/or is undistinguishable from an image descriptive of seismic measurements that are captured by a DAS system in VSP data acquisition and/or any other fake/synthetic data generated by the generator 504 that has a threshold similarity to and/or is undistinguishable from real data captured by one or more devices, such as one or more sensors (e.g., optical fiber cables).

In some examples, the generator 504 can transfer one or more attributes of data from a dataset of the same type of (and/or providing real or representative examples of) the output 506 to the input data 502 used to generate the output 506. In some cases, the generator 504 can additionally or alternatively modify the input data 502 to implement one or more characteristics of data from such a dataset and/or to exclude one or more characteristics of the input data 502 that are not included in data from such a dataset.

In some cases, the output 506 can include the input data 502 modified to include one or more characteristics and/or attributes of data of a sample dataset that is representative of a desired output. The one or more characteristics and/or attributes of the data of the sample dataset can include, for example and without limitation, one or more occlusions, one or more features, one or more patterns, one or more objects, one or more perspectives, a data value(s), and/or one or more conditions associated with the data and/or a target captured by or in the data.

In some aspects, the generator 504 can send the output 506 to the discriminator 508. The discriminator 508 can be configured to recognize a type of data associated with the output 506 and/or determine whether data from the generator 504 corresponds to the type of data associated with the output 506 or not. In some cases, the discriminator 508 can be configured to determine whether the output 506 was generated by the generator 504 and/or includes synthetic data generated by the generator 504, or whether the output 506 includes real seismic data. In some cases, the goal of the generator 504 can include to fool or trick the discriminator 508 into recognizing the output 506 generated by the generator 504 as authentic (e.g., as real seismic data), and the goal of the discriminator 508 can include to recognize the output 506 generated by the generator 504 as fake. In some examples, the goal of the generator 504 can include to generate realistic data with one or more specific characteristics and/or attributes corresponding to and/or transferred from data collected from a sensor(s) and/or a dataset of real data, and the goal of the discriminator 508 can include to recognize the one or more specific characteristics and/or attributes.

The discriminator 508 can be used to distinguish between synthetic data generated by the generator 504 and real data (e.g., real seismic data) collected by one or more sensors and/or sampled from a dataset of real data, and/or to distinguish between fake data (e.g., data from the generator 504) and data from a sensor(s) and/or a dataset of real data. The discriminator 508 can generate a discrimination output 510 which can specify whether the output 506 is believed to be real (e.g., real seismic data).

In some cases, when processing the output 506, the discriminator 508 can extract features from the output 506 and analyze the extracted features to attempt to distinguish the output 506 from data from a sensor and/or sampled from a dataset of real data.

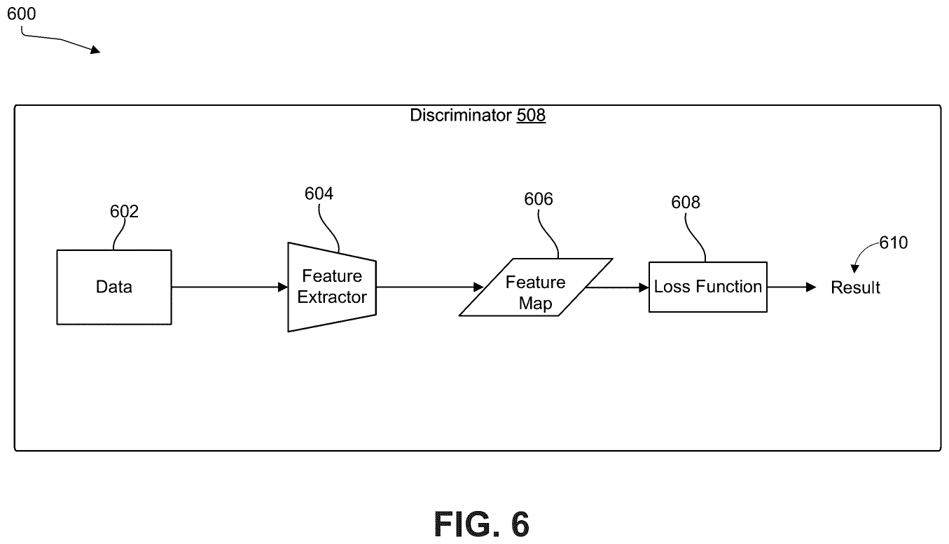

FIG. 6 is a diagram of an example configuration 600 of the discriminator 508 implemented in a GAN model (e.g., GAN model 500) to distinguish data from a generator. In this example, the discriminator 508 can receive data 602 from a generator, such as generator 504. For example, the data 602 can be the same as the output of the generator 504 illustrated in FIG. 5. The data 602 can be fed into a feature extractor 604, which can analyze the data 602 to extract features in the data 602. The feature extractor 604 can then output a feature map 606 associated with the data 602. The feature map 606 can be fed to a loss function 608 implemented by the discriminator 508.

The discriminator 508 can apply the loss function 608 to the feature map 606 from the feature extractor 604. In some examples, the loss function 608 can include a least squares loss function. The loss function 608 can output a result 610. In some examples, the result 610 can be a binary or probabilities output such as [true, false] or [0, 1]. Such output (e.g., result 610) can, in some cases, provide a classification or discrimination decision. For example, in some cases, the output (result 610) can recognize or classify the data 602 as including real seismic data or including synthetic data generated by a generator (e.g., generator 504).

In some examples, the GAN model 500 used to generate denoised seismic data (e.g., denoised seismic image 400 as illustrated in FIG. 4) can comprise a plurality of discriminative models (e.g., discriminators). For example, the GAN model 500 can include a local discriminative model (e.g., a noise model) that analyzes the noise and a signal discriminative model (e.g., a signal or non-noise model) that analyzes the signals.

In some examples, the GAN model 500 used to generate denoised seismic data (e.g., denoised seismic image 400 as illustrated in FIG. 4) can include a loss-sensitive GAN model. In particular, the loss-sensitive GAN model trains a loss function to distinguish between real and fake data by designated/pre-determined margins, while learning the generator 504 alternately to produce realistic data by minimizing the losses.

In some cases, the loss-sensitive GAN model can be based on a transformer architecture. For example, the GAN model 500 can include a transformer to synthesize pixels of the seismic input image (e.g., seismic image 200) in an auto-regressive manner so that the generator 504 increases the resolution of features within the seismic input image and the GAN model 500 outputs a high-resolution output image (e.g., denoised seismic image 400).

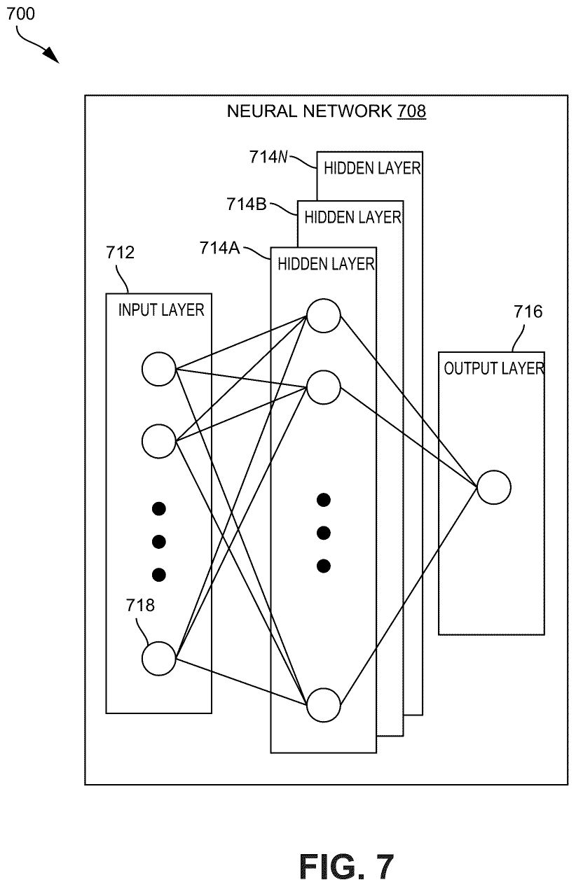

FIG. 7 illustrates an example configuration 700 of a neural network 708 that can be implemented by a model such as the GAN model 500, the generator 504, and/or the discriminator 508. The example configuration 700 is merely one illustrative example provided for clarity and explanation purposes. One of ordinary skill in the art will recognize that other configurations of a neural network are also possible and contemplated herein.

In this example, the neural network 708 includes an input layer 712 which includes input data. The input data can include seismic data such as, for example, seismic data (e.g., VSP data) acquired by a DAS system, which uses one or more optical fiber cables, in a wellbore environment depicted in FIGS. 1A and 1B. For example, the input data can include seismic image 200 previously described with respect to FIG. 2. The input data can include optical data that is communicated up a wellbore using one or more fiber optic channels and represents a spatial relationship between wellbore depth and time with respect to seismic measurements.

The neural network 708 includes hidden layers 714A through 714N (collectively “714” hereinafter). The hidden layers 714 can include n number of hidden layers, where n is an integer greater than or equal to one. The number of hidden layers can be made to include as many layers as needed for a given application. The neural network 708 further includes an output layer 716 that provides an output resulting from the processing performed by the hidden layers 714. In one illustrative example, the output layer 716 can provide a classification and/or localization of one or more objects in an input, such as an input of sensor data. The classification can include a class identifying the type of object or scene (e.g., a car, a pedestrian, an animal, a train, an object, or any other object or scene), a decision, a prediction, etc. In some cases, a localization can include a bounding box indicating the location of an object or scene.

The neural network 708 can include a multi-layer deep learning network of interconnected nodes. Each node can represent a piece of information. Information associated with the nodes is shared among the different layers. In some examples, each layer can retain information as information is processed. In some cases, the neural network 708 can include a feedforward network, in which case there are no feedback connections where outputs of the network are fed back into itself. For example, the neural network 708 can implement a backpropagation algorithm for training the feedforward neural network. In some cases, the neural network 708 can include a recurrent neural network, which can have loops that allow information to be carried across nodes while reading in input.

Information can be exchanged between nodes through node-to-node interconnections between the various layers. Nodes of the input layer 712 can activate a set of nodes in the first hidden layer 714A. For example, as shown, each of the input nodes of the input layer 712 is connected to each of the nodes of the first hidden layer 714A. The nodes of the hidden layer 714A can transform the information of each input node by applying activation functions to the information. The information derived from the transformation can be passed to and can activate the nodes of the next hidden layer (e.g., 714B), which can perform their own designated functions. Example functions include convolutional, up-sampling, data transformation, pooling, and/or any other suitable functions. The output of the hidden layer (e.g., 714B) can activate nodes of the next hidden layer (e.g., 714N), and so on. The output of the last hidden layer can activate one or more nodes of the output layer 716, at which point an output is provided. In some cases, while nodes (e.g., node 718) in the neural network 708 are shown as having multiple output lines, a node has a single output and all lines shown as being output from a node represent the same output value.

In some cases, each node or interconnection between nodes can have a weight that is a set of parameters derived from training the neural network 708. For example, an interconnection between nodes can represent a piece of information learned about the interconnected nodes. The interconnection can have a numeric weight that can be tuned (e.g., based on a training dataset), allowing the neural network 708 to be adaptive to inputs and able to learn as more data is processed.

The neural network 708 can be pre-trained to process features from the data in the input layer 712 using the different hidden layers 714 in order to provide the output through the output layer 716. In an example in which the neural network 708 is used to identify objects or features in images, the neural network 708 can be trained using training data that includes images and/or labels. For instance, training images can be input into the neural network 708, with each training image having a label indicating the classes of the one or more objects or features in each image (e.g., indicating to the network what the objects are and what features they have).

In some cases, the neural network 708 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 708 is trained enough so that the weights of the layers are accurately tuned.

For the example of identifying objects in images, the forward pass can include passing a training image through the neural network 708. The weights can be initially randomized before the neural network 708 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 708, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 708 is unable to determine low level features and thus cannot make an accurate determination of what the classification of the object might be. A loss function can be used to analyze errors in the output. Any suitable loss function definition can be used.

The loss (or error) can be high for the first training images since the actual values will be different than the predicted output. The goal of training is to minimize the amount of loss so that the predicted output is the same as the training label. The neural network 708 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 708 can include any suitable deep network. For example, the neural network 708 can include an artificial neural network, a convolutional neural network (CNN), a GAN, a generator, a discriminator, etc. In some examples, a CNN can include an input layer, one or more hidden layers, and an output layer, as previously described. The hidden layers of a CNN can include a series of convolutional, nonlinear, pooling (e.g., for down sampling), and fully connected layers. In other examples, the neural network 708 can represent any other deep network other than an artificial neural network or CNN, such as an autoencoder, a deep belief nets (DBNs), a Recurrent Neural Networks (RNNs), etc.

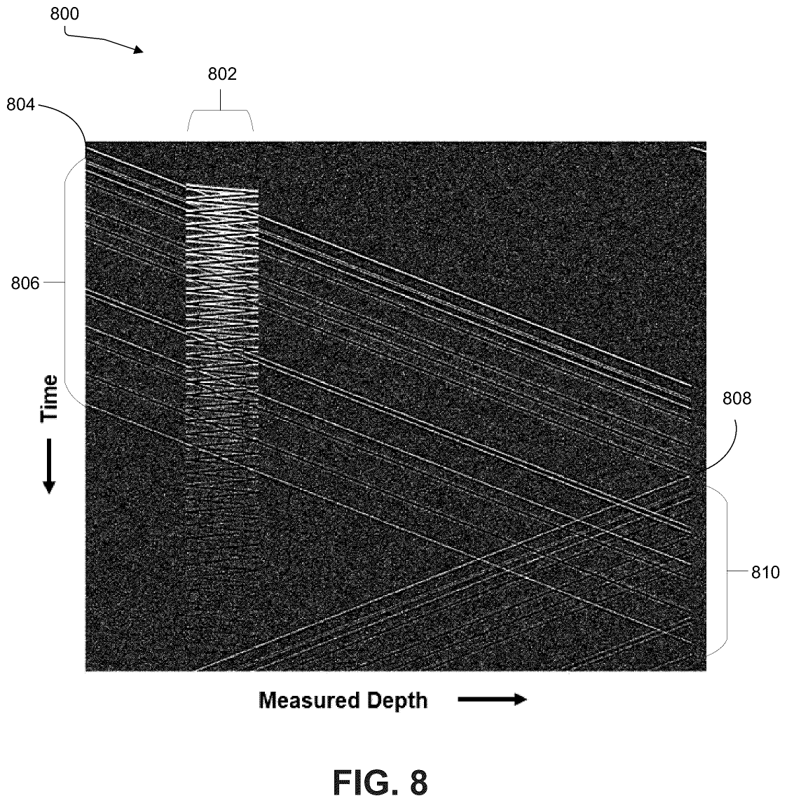

FIG. 8 illustrates an example of synthetic seismic image data 800 that can be used to facilitate the training of a machine learning model (e.g., GAN model 500). For example, the synthetic seismic image data 800 can be used to facilitate the generation of denoised seismic data process (e.g., a noise removal process and reconstruction of signals obscured behind the noise) of the disclosed technology. The machine-learning model (e.g., GAN model 500) can be trained using a dataset comprising input images with a DAS coupling noise (e.g., zigzag noise) such as synthetic seismic image data 800. In such instances, the machine learning training procedure may be designed to minimize a loss function.

As shown, the synthetic seismic image data 800 include direct wave 804 and its corresponding down-going multiples 806, up-going reflection 808 and its corresponding up-going multiples 810, and a noise region 802 comprising a zigzag noise. In some examples, the synthetic zigzag noise in the synthetic noise region 802 within the synthetic seismic image data 800 can be generated using randomly generated parameters e.g., for width and/or depth. Additionally, velocity parameters can be varied such that velocities for zig (e.g., down-going velocity) and zag (e.g., up-going velocity) portions of the added noise component are not identical. The zigzag noise in the noise region 802 can have random and varying up-going and down-going velocities, random width and height with varying temporal attenuation, and varying positions along the VSP, all of which are within upper and lower physical bounds. In some examples, the training data (e.g., the synthetic seismic image data 800) to facilitate the training of a machine learning model (e.g., GAN model 500) can include Gaussian random noise to avoid absolute zeros (e.g., stabilizing the optimization) and to more closely simulate real seismic data with zigzag noise that is typically detected in field data.

In some examples, synthetic seismic image data 800 that contain zigzag noise can be generated based on collected field data as previously described. For example, a coupling noise as appeared in noise region 902 can be randomly added to real data that does not have any coupling noise on the fly within the network. In another example, the training dataset can be augmented to look like the application (e.g., prediction) dataset.

Alternatively, the seismic data for training (e.g., synthetic seismic image data 800) may be synthetically generated, for example, using a velocity model or other modeling technique, such as by using a full elastic/acoustic seismic modeling process. In some implementations, for example where the seismic data is synthetically generated, random noise such as various realizations of simulated zigzag noise may be added to the seismic data, to increase data variance to improve the quality of the seismic data for use in an ML training process.

In some cases, the seismic data for training (e.g., synthetic seismic image data 800) can be created promptly while processing seismic input image data (e.g., seismic image 200) and passed to a machine learning model (e.g., GAN model 500) for training.

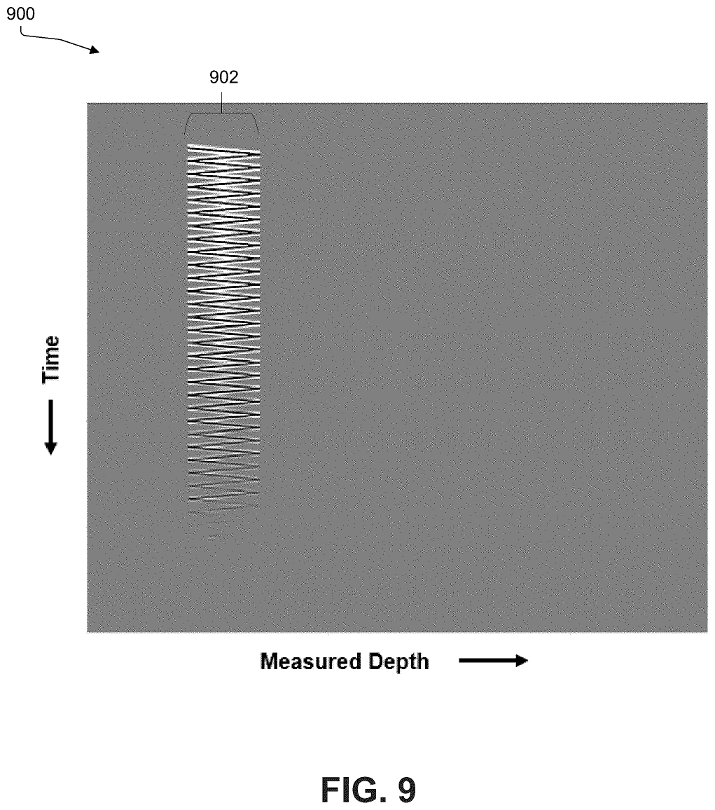

FIG. 9 illustrates an example of a synthetic noise image 900 comprising a noise region 902. In some examples, the synthetic noise image 900 comprises zigzag noise in the noise region 902 that corresponds to the noise region 802 in the synthetic seismic image data 800 of FIG. 8. In some examples, a machine learning technique can be used, when the synthetic seismic image data 800 is fed into a machine learning model, to extract the noise region 802 and generate the synthetic noise image 900 that identifies the noise region 902. For example, a machine-learning algorithm can be trained with various VSP records (e.g., field data or synthetic data) in the training data set and then applied to the synthetic seismic image data 800 in FIG. 8. The resultant estimate of the zigzag noise is illustrated in the synthetic noise image 900 of FIG. 9.

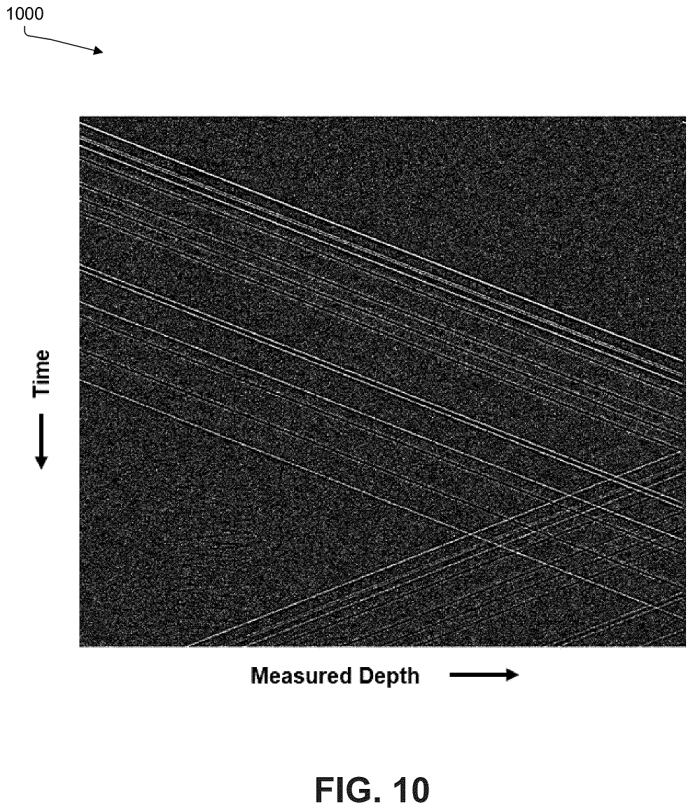

FIG. 10 illustrates an example of a synthetic denoised seismic image 1000 where a noise region (e.g., noise region 802) is eliminated from the synthetic seismic image data 800 of FIG. 8. For example, the synthetic denoised seismic image 1000 can be generated based on a machine learning model that extracts the estimated zigzag noise (e.g., zigzag noise in the noise region 802 or 902) from the input VSP record (e.g., the synthetic seismic image data 800). In particular, the machine learning model can not only identify the noise region but also eliminates the noise from the input record and directly output denoised seismic data.

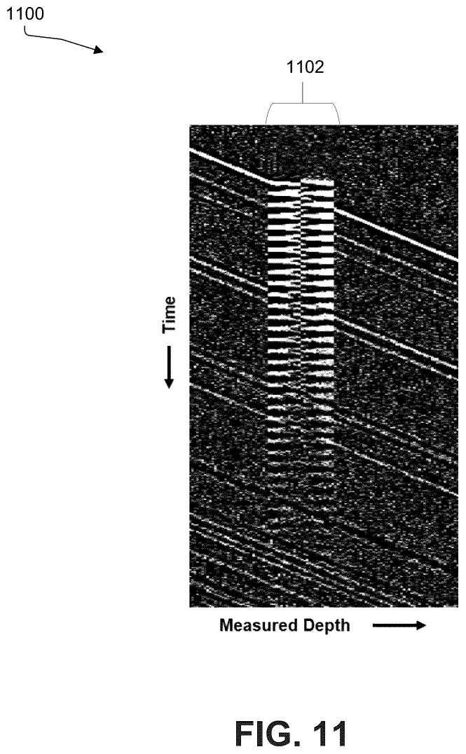

FIG. 11 illustrates an example of a synthetic zigzag noise image 1100 that can be added to a seismic record. In particular, the synthetic zigzag noise image 1100 includes one of the variations of a zigzag noise that has varying polarities across the spatial x-direction and has a “zipper” pattern. For example, half of the zigzag noise can have opposite polarity compared to the other half in the x-direction as shown in the synthetic zigzag noise image 1100. In some examples, the zipper noise pattern can be created by making a moveout velocity of the zipper pattern fast (e.g., 10,000 m/s) and randomly flipping the polarity of the traces about halfway through the zone.

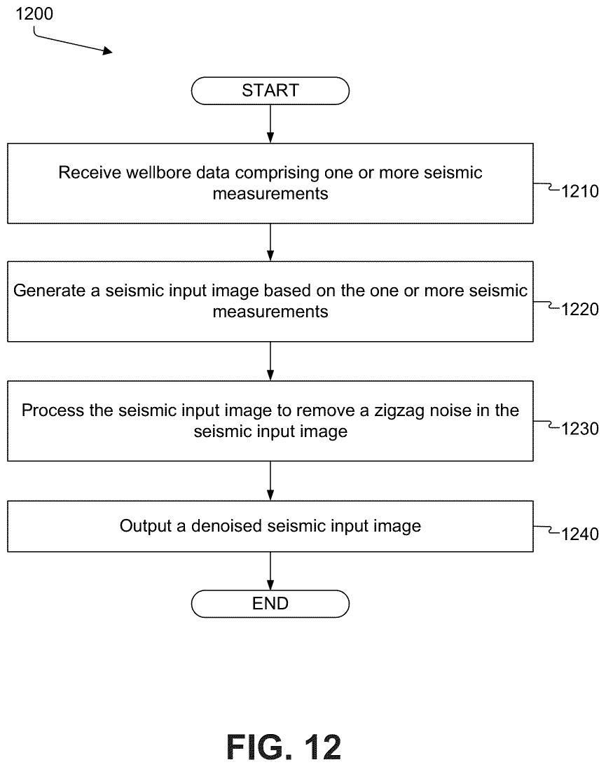

FIG. 12 is a flowchart illustrating an example process 1200 for generating denoised seismic data where a coupling noise is eliminated. Although example process 1200 depicts a particular sequence of operations, the sequence may be altered without departing from the scope of the present disclosure. For example, some of the operations depicted may be performed in parallel or in a different sequence that does not materially affect the function of process 1200. In other examples, different components of an example device or system that implements process 1200 may perform functions at substantially the same time or in a specific sequence.

At block 1210, process 1200 can include receiving wellbore data comprising one or more seismic measurements. For example, the systems and techniques described herein can receive wellbore data that includes seismic measurement data. As discussed above, the seismic measurement data can include VSP data that is received from a DAS system in a wellbore environment depicted in FIGS. 1A and 1B.

At block 1220, process 1200 can include generating a seismic input image based on the one or more seismic measurements. For example, the wellbore data can be processed to generate a seismic input image (e.g., seismic image 200 as illustrated in FIG. 2) comprising visual representations of the seismic measurements (e.g., seismic waves). In some examples, the seismic input image can include one or more noise regions (e.g., noise regions 202, 204 as illustrated in FIG. 2). As illustrated, the noise regions contain a DAS coupling noise such as a zigzag noise that obscures the signals such that the seismic measurement in the noise regions are hidden behind the zigzag noise. In some examples, the zigzag noise can have a zipper pattern where half of the zigzag noise can have opposite polarity compared to the other half in the x-direction as illustrated in FIG. 11.

At block 1230, process 1200 can include processing the seismic input image to remove a zigzag noise in the seismic input image. As illustrated previously, the seismic input image can be processed, using one or more machine-learning techniques, to eliminate a zigzag noise (e.g., zigzag noise identified in the noise regions 202, 204) in the seismic input image (e.g., seismic image 200). For example, the seismic input image can be provided to a deep-learning network or a GAN, which is configured to remove the zigzag noise in the seismic input image and output a denoised seismic image data. In some examples, a GAN model to generate denoised seismic image data can include multiple discriminative models. For example, the GAN model can comprise a local discriminative model for noise and a signal discriminative model for non-noise.

At block 1240, process 1200 can include outputting a denoised seismic image. For example, the GAN model 500 can output denoised seismic image 400 where the zigzag noise has been eliminated and the signals obscured behind the noise have been reconstructed.

FIG. 13 illustrates an example computing system 1300 including components in electrical communication with each other using a connection 1305 upon which one or more aspects of the present disclosure can be implemented. For example, depending on implementation, computing system 1300 can be implemented at the surface or downhole. Additionally, it is understood that the computing system 1300 can be implemented in both surface and downhole hardware, depending on the desired implementation. Connection 1305 can be a physical connection via a bus, or a direct connection into processor 1310, such as in a chipset architecture. Connection 1305 can also be a virtual connection, networked connection, or logical connection.

In some embodiments computing system 1300 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 1300 includes at least one processing unit (CPU or processor) 1310 and connection 1305 that couples various system components including system memory 1315, such as read only memory (ROM) 1320 and random access memory (RAM) 1325 to processor 1310. Computing system 1300 can include a cache of high-speed memory 1312 connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. There is no restriction on operating on any particular hardware arrangement and therefore the basic features here may easily be substituted for improved hardware or firmware arrangements as they are developed.

Storage device 1330 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

Storage device 1330 can include software services, servers, services, etc., that when the code that defines such software is executed by processor 1310, it causes the system to perform a function. In some embodiments, a hardware service that performs a particular function can include the software component stored in a computer-readable medium in connection with the necessary hardware components, such as processor 1310, connection 1305, output device 1335, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Example 1. A method comprising: receiving wellbore data comprising one or more seismic measurements; generating a seismic input image based on the one or more seismic measurements; processing the seismic input image to remove a zigzag noise in the seismic input image, wherein the zizag noise represents noise in the one or more corresponding seismic measurements; and outputting a denoised seismic image.
Example 2. The method of Example 1, wherein processing the seismic input image to remove the zigzag noise in the seismic input image comprises: providing the seismic input image to a machine-learning model, wherein the machine-learning model comprises a deep-learning network.
Example 3. The method of Example 1 or 2, wherein processing the seismic input image to remove the zigzag noise in the seismic input image comprises: providing the seismic input image to a machine-learning model, wherein the machine-learning model comprises a generative adversarial network.
Example 4. The method of Example 3, wherein the generative adversarial network comprises a plurality of discriminative models.
Example 5. The method of any of Examples 1 to 4, wherein the zigzag noise comprises a coupling noise caused by an uncoupling between an optic cable and a casing in a wellbore.
Example 6. The method of any of Examples 1 to 5, wherein the zigzag noise comprises a noise region having varying polarities through the noise region in depth.
Example 7. The method of any of Examples 1 to 6, wherein the wellbore data comprises vertical seismic profile data that is collected using one or more fiber optic cables.
Example 8. A system comprising: one or more processors; and a computer-readable medium comprising instructions stored therein, which when executed by the processors, cause the processors to perform operations comprising: receiving wellbore data comprising one or more seismic measurements; generating a seismic input image based on the one or more seismic measurements; processing the seismic input image to remove a zigzag noise in the seismic input image, wherein the zigzag noise represents noise in the one or more corresponding seismic measurements; and outputting a denoised seismic image.
Example 9. The system of Example 8, wherein processing the seismic input image to remove the zigzag noise in the seismic input image comprises: providing the seismic input image to a machine-learning model, wherein the machine-learning model comprises a deep-learning network.
Example 10. The system of Example 8 or 9, wherein processing the seismic input image to remove the zigzag noise in the seismic input image comprises: providing the seismic input image to a machine-learning model, wherein the machine-learning model comprises a generative adversarial network.
Example 11. The system of Example 10, wherein the generative adversarial network comprises a plurality of discriminative models.
Example 12. The system of any of Examples 8 to 11, wherein the zigzag noise comprises a coupling noise caused by an uncoupling between an optic cable and a casing in a wellbore.
Example 13. The system of any of Examples 8 to 12, wherein the zigzag noise comprises a noise region having varying polarities through the noise region in depth.
Example 14. The system of any of Examples 8 to 13, wherein the wellbore data comprises vertical seismic profile data that is collected using one or more fiber optic cables.
Example 15. A non-transitory computer-readable storage medium comprising instructions stored therein, which when executed by one or more processors, cause the processors to perform operations in accordance with any one of Examples 1 to 7.
Example 16. A system comprising means for performing a method according to any of Examples 1 to 7.

What is claimed is:

1. A method comprising:
receiving wellbore data comprising one or more seismic measurements;
generating a seismic input image based on the one or more seismic measurements;
processing the seismic input image to remove a zigzag noise in the seismic input image, wherein the zizag noise represents noise in the one or more corresponding seismic measurements; and
outputting a denoised seismic image.

2. The method of claim 1, wherein processing the seismic input image to remove the zigzag noise in the seismic input image comprises:
providing the seismic input image to a machine-learning model, wherein the machine-learning model comprises a deep-learning network.

3. The method of claim 1, wherein processing the seismic input image to remove the zigzag noise in the seismic input image comprises:
providing the seismic input image to a machine-learning model, wherein the machine-learning model comprises a generative adversarial network.

4. The method of claim 3, wherein the generative adversarial network comprises a plurality of discriminative models.

5. The method of claim 1, wherein the zigzag noise comprises a coupling noise caused by an uncoupling between an optic cable and a casing in a wellbore.

6. The method of claim 1, wherein the zigzag noise comprises a noise region having varying polarities through the noise region in depth.

7. The method of claim 1, wherein the wellbore data comprises vertical seismic profile data that is collected using one or more fiber optic cables.

8. A system comprising:
one or more processors; and
a computer-readable medium comprising instructions stored therein, which when executed by the processors, cause the processors to perform operations comprising:
receiving wellbore data comprising one or more seismic measurements;
generating a seismic input image based on the one or more seismic measurements;
processing the seismic input image to remove a zigzag noise in the seismic input image, wherein the zigzag noise represents noise in the one or more corresponding seismic measurements; and
outputting a denoised seismic image.

9. The system of claim 8, wherein processing the seismic input image to remove the zigzag noise in the seismic input image comprises:
providing the seismic input image to a machine-learning model, wherein the machine-learning model comprises a deep-learning network.

10. The system of claim 8, wherein processing the seismic input image to remove the zigzag noise in the seismic input image comprises:
providing the seismic input image to a machine-learning model, wherein the machine-learning model comprises a generative adversarial network.

11. The system of claim 10, wherein the generative adversarial network comprises a plurality of discriminative models.

12. The system of claim 8, wherein the zigzag noise comprises a coupling noise caused by an uncoupling between an optic cable and a casing in a wellbore.

13. The system of claim 8, wherein the zigzag noise comprises a noise region having varying polarities through the noise region in depth.

14. The system of claim 8, wherein the wellbore data comprises vertical seismic profile data that is collected using one or more fiber optic cables.

15. A non-transitory computer-readable storage medium comprising instructions stored therein, which when executed by one or more processors, cause the processors to perform operations comprising:
receiving wellbore data comprising one or more seismic measurements;
generating a seismic input image based on the one or more seismic measurements;
processing the seismic input image to remove a zigzag noise in the seismic input image, wherein the zigzag noise represents noise in the one or more corresponding seismic measurements; and
outputting a denoised seismic image.

16. The non-transitory computer-readable storage medium of claim 15, wherein processing the seismic input image to remove the zigzag noise in the seismic input image comprises:
providing the seismic input image to a machine-learning model, wherein the machine-learning model comprises a deep-learning network.

17. The non-transitory computer-readable storage medium of claim 15, wherein processing the seismic input image to remove the zigzag noise in the seismic input image comprises:
providing the seismic input image to a machine-learning model, wherein the machine-learning model comprises a generative adversarial network.

18. The non-transitory computer-readable storage medium of claim 17, wherein the generative adversarial network comprises a plurality of discriminative models.

19. The non-transitory computer-readable storage medium of claim 15, wherein the zigzag noise comprises a coupling noise caused by an uncoupling between an optic cable and a casing in a wellbore.

20. The non-transitory computer-readable storage medium of claim 15, wherein the zigzag noise comprises a noise region having varying polarities through the noise region in depth.
